(19) United States
(12) Patent Application Publication
(10) Pub. No.: US 2016/0227743 A1
(43) Pub. Date: Aug. 11, 2016

(54) METHOD AND SYSTEM FOR MONITORING FOOD PROCESSING OPERATIONS

(71) Applicant: TEN Media, LLC dba TEN Ag Tech Co., San Juan Capistrano, CA (US)

(72) Inventors: Jonathan R. Phillips, San Juan Capistrano, CA (US); Richard C. Blackburn, Santa Ana, CA (US); Scott D. Smith, Laguna Niguel, CA (US)

(73) Assignee: TEN Media, LLC dba TEN Ag Tech Co., San Juan Capistrano, CA (US)

(21) Appl. No.: 15/007,147

(22) Filed: Jan. 26, 2016

Related U.S. Application Data
(60) Provisional application No. 62/107,526, filed on Jan. 26, 2015.
(60) Provisional application No. 62/107,531, filed on Jan. 26, 2015.
(60) Provisional application No. 62/107,533, filed on Jan. 26, 2015.

(51) Int. Cl. A01K 43/00

(52) U.S. Cl. CPC A01K 43/00

(57) ABSTRACT

The present disclosure includes a method and system for monitoring and managing food product processing operations and animal growing, housing, and farming operations and facilities. The food products or animals and related housing and feed are examined and/or analyzed with respect to the quality and integrity of the processing thereof, any markings applied thereto, and compliance with commercial, regulatory, or customer requirements. The environmental conditions, processing conditions, the processing performance parameters, and the like, or any combination thereof, are thereafter subjected to documentation and also may be adjusted in response to such examination, including and up to automated cessation of production.

### CROSS-REFERENCE TO RELATED APPLICATIONS

This application claims the benefit of U.S. Provisional Application No. 62/107,533 filed on Jan. 26, 2015, U.S. Provisional Application No. 62/107,531 filed Jan. 26, 2015, and U.S. Provisional Application No. 62/107,526 filed Jan. 26, 2015, the contents of which are incorporated herein by reference in their entirety.

### BACKGROUND

The disclosure relates generally to the field of food product processing, and more particularly methods and systems for monitoring and managing food product processing operations and facilities. The disclosure further relates to methods and systems for examining or analyzing the food products with respect to the quality and integrity of the processing thereof and any markings that may be applied to the food products and/or associated packaging. While reference is made herein to eggs in particular, it should be understood that this disclosure is directed to all food processing operations as well as animal growing, housing, and farming operations.

In the egg packing industry, eggs typically undergo a great deal of processing before they are ready to be sold to the consuming public. In many circumstances, for example, eggs pass through several processing stations where they are washed, candled, weighed, graded, and packed into packages (e.g., cartons, crates, or other commercially distributed containers). Examples of such processing stations and mechanisms for conveying eggs from station to station are described, for instance, in the following U.S. patents assigned to Diamond Automations, Inc. (U.S. Pat. Nos. 4,189,898; 4,195,736; 4,505,373; 4,519,494; 4,519,505: 4,569,444; 4,750,316; 5,321,491; and 6,056,341) and TEN Media LLC (U.S. Pat. No. 8,455,030), which are incorporated herein by reference in their entirety. As a reference, it is not uncommon for a facility in which these stations operate to output about one million eggs in a single day. Accordingly, to be commercially acceptable, the throughput of the stations needs to be quite high, with some stations typically processing on the order of 20,000 eggs per hour.

The egg packing industry uses devices known as “packers” to pack the eggs into the packages. Typically, a packer includes a conveyor (e.g., a belt conveyor, roller conveyor, chain conveyor, etc.) that moves empty packages through an egg loading section (where the eggs are loaded into the egg loading section from above) and then moves the filled packages to a package closing section that is responsible for closing the lids of the packages. The eggs may be supplied to the egg packer via a grader system.

An egg packing process that uses “packers,” typically uses bulk belts to bring eggs from a bulk supply location. The eggs are cleaned or disinfected, in some instances using UV light while clamped to transport chains, and in some instances through immersion in sanitizing wash water. The eggs are then inspected either electronically or manually, they are weighed to establish size, inspected for cracks using ultrasonic inspection and loaded into a chain driven carriage mechanism (“Transfer Loader”). The egg is then normally transported to one of a plurality of packing machines by the aforementioned carriage mechanism. The particular packing machine to which any individual egg may be transported is determined by a computer. This process or elements thereof up to, but not including the packing machine, constitute grading (“Grading” and the “Grader”). The carriage mechanism typically consists of one or a plurality of chains, running the length of the Grader past all the packing machines in the horizontal plane (“Grader Chains”). The packing machines are usually configured with an egg flow perpendicular to the Grader Chain in the horizontal plane.

The egg industry widely uses marking devices to print Size, Grade and Date information together with other information or images and logos (“Data”) on to the surface of an egg shell of a fresh egg travelling through an egg grading machine. The marking devices are traditionally placed in a location on the production line that is responsible for grading the eggs and the site for such installation is chosen to minimize the number of marking devices required for a given installation. Marking devices have typically been installed on the Grader Chains as near to the Transfer Loader as practical, and typically (although not always), prior to all the packing machines to which almost all eggs are later diverted.

Bacteria are a group of microscopic, unicellular microorganisms that lack a distinct nucleus and reproduce by cell division. Bacteria typically range from 1 to 10 micrometers in size and vary in the ways they obtain energy and nourishment. About 200 species of bacteria are pathogenic; pathogenicity varies among the species and is dependent on both the virulence of the species and the condition of the host organism.

The E. coli 0157:H7 and Salmonella microorganisms are just two of the most well-known pathogenic bacteria which may cause death in humans.

It is well-known that bacteria is involved in the spoilage of consumable products, to which this disclosure is directed. Bacteria may actually render such foods unpalatable by changing their composition. Bacteria growth can also lead to food poisoning such as that caused by clostridium botulinum or Staphylococcus aureus.

It is well-known that bacteria find a ready source of nutrients inside the shell of an egg, and can multiply quickly in that environment. Such infected eggs may be hazardous to health but the bacterial presence in the egg may not be recognized before the egg is processed or consumed. Therefore it is imperative to prevent bacteria from easily migrating from the surface of the egg shell, into the interior of the egg. Bacteria can migrate through the naturally occurring pores in the egg shell, but much more readily migrate through cracks in the shell. Such cracks may be so small as to be invisible to the unaided eye, but facilitate bacterial migration all the same.

Regulations, coupled sometimes with more stringent retailer requirements, limit the proportion of cracked eggs amongst eggs sold at retail. Typically the USDA requires that less than 7% of eggs have any cracks, visible or otherwise, at retail (9% maximum for Jumbo eggs). Many states have adopted similar regulations relating to shell eggs sold at retail. Eggs found during processing (grading and candling operations) in excess of this proportion, less an allowance for cracking occurring during transportation from the processing facility to the retail store, are diverted and sent for alternate processing, such as breaking, which may result in a lower price for the egg and therefore less revenue for the processing facility.

Therefore during egg processing, there are economic reasons as well as food safety reasons, for the egg processing facility to avoid inducing cracks in eggs during washing, candling, grading and packing operations.

Experts in Food Safety and Regulators have long recognized that bacterial load on the surface of the egg constitutes a food safety risk, in that bacteria on the surface of the egg shell can easily cross-contaminate to other surfaces and food products when the consumer opens the egg cartons to examine the eggs inside prior to purchase at retail or within the home. Additionally it is beneficial to reduce the bacterial count on the surface of the egg, to minimize the population of bacteria which may migrate to the interior of the egg via cracks in the egg shell. As described previously, such penetration of the egg shell by bacteria can present a serious health risk to the ultimate consumer of such a spoiled egg

Therefore regulations are in place, requiring that all eggs sold at retail or for Food Service (restaurants and the like) should be washed and sanitized prior to packaging, and then refrigerated until sold at retail or used at a food service location

The cleaning of eggs in a commercial setting is required to remove the contaminants and bacteria from the surface of an egg shell. Until cleaned, the shell is a known breeding ground for various types of bacteria, the most notorious of which is the salmonella enteritidis. An egg effectively has four layers. The cuticle is a thin layer of hard protective coating followed by a thick layer of calcium carbonate which forms the shell, but is also porous. Beneath the calcium carbonate shell are two membranes which are porous, thereby relying on the cuticle to be the main barrier to prevent bacteria from entering into the egg via the porous openings of the shell and the two inner membranes. As eggs are a natural product, variations from egg to egg in cuticle thickness are to be expected.

Washing and sanitizing of the eggs can reduce the thickness of the cuticle, thereby reducing the effectiveness as a protective barrier against bacterial migration. Parameters controlled in the washing process, including but not limited to water temperatures, water pH levels, and chemical characteristics of the type of sanitizer used, can impact the proportion and degree of cuticle removal during washing. As eggs are a natural product, variations from egg to egg in the susceptibility to degradation of the cuticle are to be expected.

When washing eggs, egg temperature during processing is very important. USDA regulations require that wash water temperature be at 90° F. or higher, or at least 20° F. warmer than the highest egg temperature (whichever is greater). These temperatures must be maintained throughout the cleaning cycle. Temperature of incoming eggs will vary from season to season and from operation to operation. In off-line processing plants (where eggs are brought in from off-premises) initial internal egg temperatures of 62 to 68° F. (16.7 to 20° C.) are likely. Although pre-processing coolers are held generally between 50 to 60° F., egg temperatures decline only slightly. Egg temperatures at processing reflect initial internal temperatures generally, because eggs are brought into the processing plants (where the processing plant is adjacent to production facilities) internal egg temperatures range generally from 88 to 96° F. (31.1 to 35.6° C.) when they reach the processing area.

In other processing equipment embodiments, incoming egg temperatures from inline farms generally range from 60 to 80° F. In further embodiments, eggs from offline farms are transported in refrigerated trucks and held in the finished goods cooler at the processing location, both of which are required by regulation to be maintained at 40 to 45° F. Therefore, eggs from offline farms may be at a temperature between 40 and 45° F. during storage. Such eggs must be removed from the cooler and allowed to warm to room temperature, typically ranging from 55 to 70° F., before processing is permitted.

Regulations require also, that wash water be changed every four hours or more frequently if needed, to maintain sanitary conditions. When the difference between wash water temperature and egg temperature is greater than 40° F., thermal checks and cracks increase, allowing surface microbes more direct access to the interior of the egg. In processing equipment embodiments where eggs may be stored in a cooler prior to processing, the possibility that this temperature differential may be exceeded is much greater, due to incorrectly allowing inadequate time for eggs to warm prior to processing. In processing equipment embodiments where inline internal egg temperatures may reach 80° F., attention is required to the wash water temperature to ensure that the required 20° F. temperature differential between egg and wash temperatures is maintained.

In general, the effectiveness of cleaning eggs during washing is related to: wash water temperature, water quality characteristics (i.e. hardness, pH), detergent type and concentration, and defoamer. Replacement water in washer tanks should be added continuously to maintain a constant overflow rate, according to USDA regulations.

Because of the possibility of bacterial migration into the interior of the egg if these processing temperature requirements are not met, it is important that the eggs are processed in compliance with the sanitary requirements of the USDA and others. In the situation where these eggs are to be marked with either ink or energy from a laser, it is important to know if the processed eggs are compliant with sanitary requirements prior to marking. Further, it is important to know if the markings as applied thereon are in compliance with any commercial, regulatory, customer, or the applicable requirements.

### BRIEF SUMMARY

The following presents a simplified overview of the example embodiments in order to provide a basic understanding of some aspects of the example embodiments. This overview is not an extensive overview of the example embodiments. It is intended to neither identify key or critical elements of the example embodiments nor delineate the scope of the appended claims. Its sole purpose is to present some concepts of the example embodiments in a simplified form as a prelude to the more detailed description that is presented later.

In accordance with embodiments herein, the present disclosure includes a method and system for monitoring and managing food product processing operations and facilities. The food products are examined and/or analyzed with respect to the quality and integrity of the processing thereof, any markings applied thereto, and compliance with commercial, regulatory, or customer requirements. The environmental conditions, processing conditions, the processing performance parameters, and the like, or any combination thereof, to which the food products are subjected may be adjusted in response to such examination.

In accordance with embodiments herein, the food products may be examined at selected times, selected stages of the processing operations, with respect to selected food product characteristics, environmental conditions, processing conditions, or performance parameters, with respect to selected compliance requirements, or any combination thereof.

In a preferred embodiment, the present disclosure includes a method and system for monitoring and managing food product processing operations, wherein such processing operations include applying markings on the food product. The markings are applied in such a manner to form a permanent marking thereon. The markings may include text, graphics, images, other types of indicia, and any combination thereof. The markings are applied by any suitable marking device known in the art, such as laser-based or ink-based technologies. Desirably, the marking is applied so as to leave much of the area of the food product unaffected so as to form contrast between the unaffected areas and the marking. The method preferably forms the markings on the food product while the product moves through a predetermined region of a food processing system. The performance or characteristics of the marking device may be adjusted in response to selected characteristics of the food product, environmental conditions, processing conditions, compliance requirements, and the like, in order to optimize the marking process.

In a preferred embodiment, the present disclosure includes an apparatus for applying markings on food products that is operable in association with a food packing system that packages the food products. The apparatus comprises a marking device located in proximity to the food packing system so that the marking device can form markings thereon.

A preferred embodiment includes an apparatus for applying markings on eggs that is operable in association with an egg-handling machine that performs washing, candling, grading, and packing of eggs. The apparatus comprises a marking device located in proximity to the egg-handling machine, so that the marking device can form the markings. In a preferred embodiment, the egg has a marking applied thereon, wherein the marking is formed at least in part by discolored material on the egg shell. The egg may include the marking being formed entirely by discolored material of the egg shell. The egg may also be raw or pasteurized or hard-boiled. The markings may be formed by a generally stationary marking device as the egg is transported past the marking device, or in other embodiments, the source may reciprocate and move concurrently with the egg transport mechanism.

In some embodiments, the method and system for applying markings on food products, comprises conveying the food product to a marking station having at least one laser marking device configured to apply laser energy of sufficient intensity to etch indicia on the food product, and activating the laser device to apply laser energy to the food product and etch the indicia thereon. The markings may include text, graphics, images, other types of indicia, and any combination thereof. In a preferred embodiment, the food product is an egg, and the laser etches the indicia on the outer surface of the shell of the egg. The applied laser energy may ablate and melt the surface of the egg shell to an approximate depth that is within the range of about 5 to about 25 micrometers. The applied laser energy may ablate and/or discolor the surface of the egg shell to an approximate depth that is within the range of about 1.5 to about 8 percent of the thickness of the egg shell.

The food products are examined and/or analyzed with respect to the quality and integrity of the processing thereof, the markings applied thereto, and compliance with commercial, regulatory, or customer requirements. The environmental conditions, processing conditions, the marking process performance parameters, and the like, or any combination thereof, of the marking process may be adjusted in response to such examination. The food products may be examined prior to, during, and/or after the marking process.

In a preferred embodiment, the food products are examined and/or analyzed with respect to the quality and integrity of the processing thereof, any markings applied thereto, compliance with commercial, regulatory, or customer requirements, and the like (“quality data”), and quality data obtained therefrom is suitably stored in memory for later use. Quality data obtained may be stored in memory local to the processing operations and/or remotely by any suitable means. The quality data may be accessed and analyzed by any suitable means to determine any variations, trends, problems, and the like.

In a preferred embodiment, quality data is also collected from third parties, wherein such third party is an entity other than the egg processing facility. Such third party may be the source location, veterinary facilities, testing laboratories, distributors, and the like. Such third parties will obtain and/or collect data related to the eggs that are being processed as well as environmental or processing conditions associated with the eggs.

In a preferred embodiment, quality data may be obtained or collected from multiple sources, such as multiple food products, multiple processing runs on a device or system, multiple marking devices or systems within a processing facility, multiple processing facilities, multiple distribution systems, and the like, or any combination thereof. In a preferred embodiment, the present disclosure provides a cloud-based system for collecting and archiving the quality data. The quality data contained therein may be analyzed with respect to food source location details, food processing facility details, food processing environmental and processing conditions, food product characteristics, food product distribution details, regulatory compliance details, and the like.

In a preferred embodiment, the collection of the quality data and the analysis thereof are determined automatically, without human intervention, so as to avoid human interference or subjectiveness in the quality control process. In such an embodiment, the food products which are to be examined with respect to selected times, selected stages of the processing operations, selected food product characteristics, environmental conditions, processing conditions, or performance parameters, selected compliance requirements, are determined by a quality analysis protocol, and an operator doing such examinations is less likely to bias the results. For example, a quality control operator working at an egg processing facility is given instructions as to which sample are collected, from which location, and at what times. This ensures a random, and therefore, even distribution of sample locations. The quality data obtained is analyzed not only with respect to individual results, but also with respect to patterns and sample frequency/effectiveness of sampling. The outcome is to prevent selective sampling by the operator, based on pre-conceived ideas or results.

In a preferred embodiment, statistical analysis of the quality data may be carried out after grouping results together, such groupings being determined by processing parameters common to the group under consideration and comparing them against 3 subsets of specific rules groupings: i) law and statutory obligations; ii) client requirements and contractual requirements; and iii) internal regulations and constraints. Results of such analysis may trigger corrective actions to be taken at the egg processing facility or elsewhere, to improve or correct any deficiency or degradation in results of the quality inspections. Some of these corrective measures being actioned in real-time by digital communications or display of data on screens and panels, MMI′ (Man Machine Interfaces) or HMI's (Human Machine Interfaces). When non compliance is determined the system can determine whether such non compliance merits cessation of laser on product (egg) markings.

While reference is made to food processing operations, and eggs, in particular, it is to be understood that the present disclosure is applicable to any suitable animal growing, housing, or farming operations. In addition, the methods and systems of the present disclosure are applicable to any portion of animal growing, housing, or farming operations. For example, the methods and systems of the present disclosure allow for any or all of the egg source locations, distribution facilities, egg processing facilities, governmental agencies, and the like to access data related to a particular egg processing operation, group of processing operations, batch of product, source of product, trends related thereto, or combinations thereof. This allows for all data related to a particular processing operation to potentially be aggregated and analyzed across multiple processing operations, batches of product, sources of product, and the like, and such data and analysis stored in a storage location that is readily accessible by any authorized users for further analysis thereof.

Still other advantages, aspects and features of the subject disclosure will become readily apparent to those skilled in the art from the following description wherein there is shown and described a preferred embodiment of the present disclosure, simply by way of illustration of one of the best modes best suited to carry out the subject disclosure As it will be realized, the present disclosure is capable of other different embodiments and its several details are capable of modifications in various obvious aspects all without departing from the scope herein. Accordingly, the drawings and descriptions will be regarded as illustrative in nature and not as restrictive.

### BRIEF DESCRIPTION OF THE DRAWINGS

The accompanying drawings incorporated herein and forming a part of the specification illustrate the example embodiments.

FIG. 1 is a block diagram depicting portions of an egg-handling machine and particularly illustrating inline and offline operations.

FIG. 2 is a diagrammatic view depicting an apparatus for performing an embodiment of the method of the present disclosure.

FIG. 3 is a diagrammatic view depicting an apparatus for performing an embodiment of the method of the present disclosure.

FIG. 4 is a diagrammatic view depicting a laser printing assembly for performing an embodiment of the method of the present disclosure.

FIG. 5 illustrates an example of a computer system 500 upon which an example embodiment may be implemented.

FIG. 6 is a diagram depicting an egg bearing markings using method and apparatus embodiments of the present disclosure.

FIG. 7 is an example flow diagram of marking on eggs with the apparatus as shown in FIGS. 2 and 3 in accordance with an example implementation.

FIG. 8 is an example flow diagram for implementing testing protocols in response to a trigger event in accordance with an example implementation.

FIG. 9 is a block diagram illustrating an example embodiment of a cloud-based network for remote storage of quality data according to the present disclosure.

### DETAILED DESCRIPTION OF THE PREFERRED EMBODIMENTS

This description provides examples not intended to limit the scope of the appended claims. The figures generally indicate the features of the examples, where it is understood and appreciated that like reference numerals are used to refer to like elements. Reference in the specification to “one embodiment” or “an embodiment” or “an example embodiment” means that a particular feature, structure, or characteristic described is included in at least one embodiment described herein and does not imply that the feature, structure, or characteristic is present in all embodiments described herein.

In general, the embodiments herein provide methods and systems for monitoring and managing food product processing operations and facilities. The food products are examined and/or analyzed with respect to the quality and integrity of the processing thereof, any markings applied thereto, and compliance with commercial, regulatory, or customer requirements, and the like (“quality data”). The food products may be examined at selected times, selected stages of the processing operations, with respect to selected food product characteristics, environmental conditions, processing conditions, or performance parameters, with respect to selected compliance requirements, or any combination thereof. The environmental conditions, processing conditions, the processing performance parameters, and the like, or any combination thereof, to which the food products are subjected may be adjusted in response to such examination. The quality data may be accessed and analyzed by any suitable means to determine any variations, trends, problems, and the like. The quality data may be analyzed with respect to food source location details, food source environmental and processing conditions, food processing facility details, food processing environmental and processing conditions, food product characteristics, food product distribution details, food product distribution environmental and processing conditions, regulatory compliance details, and the like.

In a preferred embodiment, quality data is also collected from third parties, wherein such third party is an entity other than the egg processing facility. Such third party may be the source location, veterinary facilities, testing laboratories, distributors, and the like. Such third parties will obtain and/or collect data related to the eggs that are being processed.

In a preferred embodiment, the collection of the quality data and the analysis thereof are determined automatically, without human intervention, so as to avoid human interference or subjectiveness in the quality control process. In such an embodiment, the food products which are to be examined with respect to selected times, selected stages of the processing operations, selected food product characteristics, environmental conditions, processing conditions, or performance parameters, selected compliance requirements, are determined by a quality analysis protocol, and an operator doing such examinations is less likely to bias the results. For example, a quality control operator working at an egg processing facility is given instructions as to which samples are to be collected, from which location, and at what times. This assures a random, and therefore, even distribution of sample locations. The quality data obtained is analyzed not only with respect to individual results, but also with respect to patterns and sample frequency/effectiveness of sampling. The outcome is to prevent selective sampling by the operator, based on pre-conceived ideas or results

While reference is made herein to eggs in particular, it should be understood that this disclosure is directed to monitoring and managing processing operations for any suitable product, including food products for human consumption, food products for animal consumption, as well as any animal growing, housing, or farming operation. In the example embodiment, there is provided a method and system for monitoring and managing egg processing systems, and adjusting parameters in response to such monitoring. However, it is to be appreciated that the embodiments of the claims herein are not limited in any way to the example embodiment, but rather are to be interpreted to cover other suitable processing operations. In addition, the methods and systems of the present disclosure are applicable to any portion of animal growing, housing, or farming operations.

In a preferred embodiment, the present disclosure includes a method and system for monitoring and managing food product processing operations, wherein such processing operations include applying markings on the food product. The marking are applied in such a manner to form a permanent marking thereon. The markings may include text, graphics, images, other types of indicia, and any combination thereof. The markings are applied by any suitable marking device known in the art, such as laser-based or ink-based technologies. Desirably, the marking is applied so as to leave much of the area of the food product unaffected so as to form contrast between the unaffected areas and the marking. The method preferably forms the markings on the food product while the product moves through a predetermined region of a food processing system. The performance or characteristics of the marking device may be adjusted in response to selected characteristics of the food product, environmental conditions, processing conditions, compliance requirements, and the like, in order to optimize the marking process.

It is further understood that the preferred embodiment for applying a marking on eggs is by applying a radiant energy source to the shell of the egg so as to cause discoloration of the egg shell to form a permanent marking thereon. However, it is to be appreciated that the embodiments contained herein are not limited to the preferred embodiments, but rather are to be interpreted to cover applying markings by any suitable marking device.

It should be understood that the terms “marking” or “etching” as used herein are intended to mean that a laser is employed as a radiant energy source. The laser beam is applied to leave most of the egg shell unaffected so as to provide contrast between the unaffected areas and the marking. The laser beam discolors and/or ablates the outer surface material from the egg shell. A significant benefit of the use of laser marking is that brown eggs have etched indicia that is a contrasting white color, while white eggs have etched indicia that is a contrasting dark brown color. The structural integrity of the egg shell is not affected because the etching by the beam only affects the outer approximately 5 to approximately 25 micrometers of the egg shell, which is approximately 1.5% to approximately 8% of the thickness of the egg shell.

In the preferred embodiment in which a radiant energy source is used, no foreign material is required to be added to the egg shell in order for the radiant energy to discolor the egg shell. Thus, no foreign material, such as ink or radiant energy sensitive material that could react with the radiant energy needs to be added to form a marking. The radiant energy is applied to the natural eggshell. Thus, the marking most desirably is formed solely by the effect of the radiant energy on the normally occurring materials of the eggshell itself. This provides several significant benefits. The egg can be properly represented to the consumer as a product with no additives or contaminants. Moreover, because it is not necessary to apply additional materials for purposes of the marking process, it is unnecessary to add the equipment needed to coat the egg with a foreign substance. This greatly simplifies the task of performing the process inline in the production environment of an existing high-speed egg handling apparatus. Additionally, the potentially significant cost of such additional materials is avoided.

In a method according to a preferred embodiment of the present disclosure, a radiant energy source in proximity of an egg directs radiant energy towards the egg. Radiant energy source desirably includes a laser such as a CO₂ gas laser adapted to provide light at a wavelength between 9.0 and 10.7 microns, at a minimum of 25 watts, and a projected maximum of 200 watts radiated power, in a beam projected from approximately 100 mm at the surface of the egg. When operated in this power range, the beam ablates and/or discolors the outer surface material from the egg shell. The structural integrity of the egg shell is not affected because the etching by the beam only affects the outer approximately 5 to approximately 25 micrometers of the egg shell, which is approximately 1.5% to approximately 8% of the thickness of the egg shell. The beam is directed onto those areas of the egg, which are to be discolored and turned on and off so as to provide a series of pulses, the beam being “on” for up to about 60 milliseconds during each pulse. During this pulsed actuation, the beam is swept across those areas of the egg surface, which are to be discolored The sweeping motion may be performed in any manner which will provide the desired relative motion of the beam and the egg. Since the preferred embodiments will operate in association with an egg-handling machine which moves eggs at an extremely rapid speed, the beam must be rapidly moved to produce the desired indicia and also may compensate for the speed of movement of the eggs past the laser apparatus, which is preferably stationary. For example, the radiant energy source may include a beam-sweeping unit incorporating conventional optical elements such as movable or variable lenses, mirrors or prisms adapted to deflect the beam and to vary the deflection with time. Suitable radiant energy sources include, but are not limited to, Sealed CO₂ Gas Lasers, Slow-flow CO₂ Gas Lasers, TEA CO₂ Mask Lasers, CO Gas Lasers, UV Gas Lasers, Mid-IR Solid State Lasers, and solid-state visible light lasers. In other embodiments, the radiant energy source may be also be a YAG-type and/or fiber laser system, and may be coupled with a frequency multiplying optical element.

In another embodiment, an ink-based marking device is placed in proximity of an egg and directs ink toward the egg. Suitable ink-based marking systems include non-contact systems that do not directly contact the printing system with the egg surface, such as CIJ printing system discussed above. Such system may be mounted so as to mark while the eggs are contained by the calipers on the Grader Chains of an egg grading machine. The system may also be mounted on the Packer and traverse across each row of eggs, applying markings thereon. The CIJ printing system could include a single-jet CIJ printer, a dual-jet CIJ printer, or a Binary Array type of CIJ printer. In alternate embodiments, a drop-on-demand printer system may be utilized, using technologies including Thermal Inkjet (TIJ), Piezoelectric Inkjet, and MEMS-based Inkjet.

Drop-on-Demand technology can offer significantly higher resolution printing than CIJ technologies, thereby offering good potential for creating high-quality desirable sponsored images. Additionally, Drop-on-Demand technology configurations may use ink cartridges (as opposed to a large reservoir and associated pumps, valves, etc.), which can reduce equipment maintenance requirements. Drop-on-Demand technology options may be mounted above the eggs at a Grader processing step before the Grader Transfer, where the eggs travel at a lower speed and the higher resolution print can be better controlled.

Another example of an ink-based marking system is one that is mounted on the packer and uses to six independent ink sources, each arranged above one egg in a row of eggs (each row has up to 6 eggs). As the eggs pass under the ink source in their typical (as though unmarked) path through the packing machinery, ink markings are made on the surface of the egg. Such ink source could include the same technology options as discussed above.

In a method according to an embodiment of the present disclosure, an egg moves through a portion of an egg-grading machine. An egg-grading machine grades the quality of the eggs, and may also transport the eggs towards a packaging machine. Egg-grading machines will move the egg along a path. Somewhere along the path, and preferably immediately before the eggs are packed, a predetermined region can be selected where the egg will pass through and radiant energy can form markings on the egg. Typically, egg-grading machines have calipers that hold the eggs at some point in the path of the egg-grading machine. The marking device may be placed in proximity to this point when the eggs are held so that the marking device forms the markings on an egg as it passes through this predetermined region. This eliminates any need for a special apparatus to position the egg. In this way the method is performed inline with the egg-grading machine.

In another embodiment of the present disclosure, a marking device may be placed in proximity of an existing egg-handling machine. Egg-handling machines includes any device or apparatus that will control the movement of an egg along a path, including egg-grading machines. The marking device can be placed in proximity to the egg-handling machine so that the markings may be applied to the egg inline. The egg-handling machine moves an egg along a conveyor apparatus in a particular direction. A marking device is placed in proximity to the conveyor apparatus such that marking device is directed towards egg.

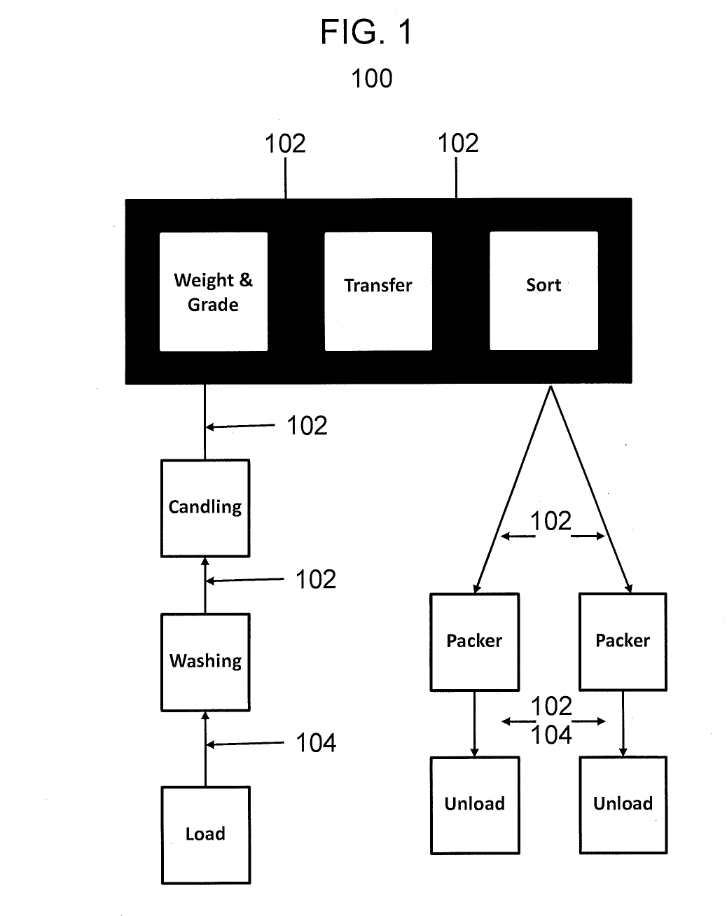

There are many variations of egg-handling machines. Most perform some common minimal basic functions. FIG. 1 is a block diagram outlining the basic functions of those machines. The eggs move through these machines 100 while these basic functions are performed, and a radiant energy source can be placed inline 102 or offline 104 in between many of these functions to perform a method of the present disclosure. The eggs are loaded into the machine. An offline procedure may be performed after this function. The eggs are then washed, after which an inline method may be performed. The eggs are candled, after which an inline method may be performed. The eggs move to the grading portion of the machine where they are weighted and graded, after which an inline method may be performed. The eggs are then transferred to a sorter, before which an inline method may be performed. The eggs are then sorted by grades and sizes, after which an inline method may be performed. The eggs are placed into a package, after which an inline method may be performed. An offline process 104 can be performed prior to the load processor and, typically involves human intervention or some other form of mechanical intervention alien to the egg-handling machine. In preferred embodiments of the present disclosure, the marking device can be associated with an existing egg-handling machine without appreciably modifying the machine. The egg-handling machine preferably includes sensors or other suitable monitoring devices for monitoring the operational and environmental parameters of the egg-handling machine.

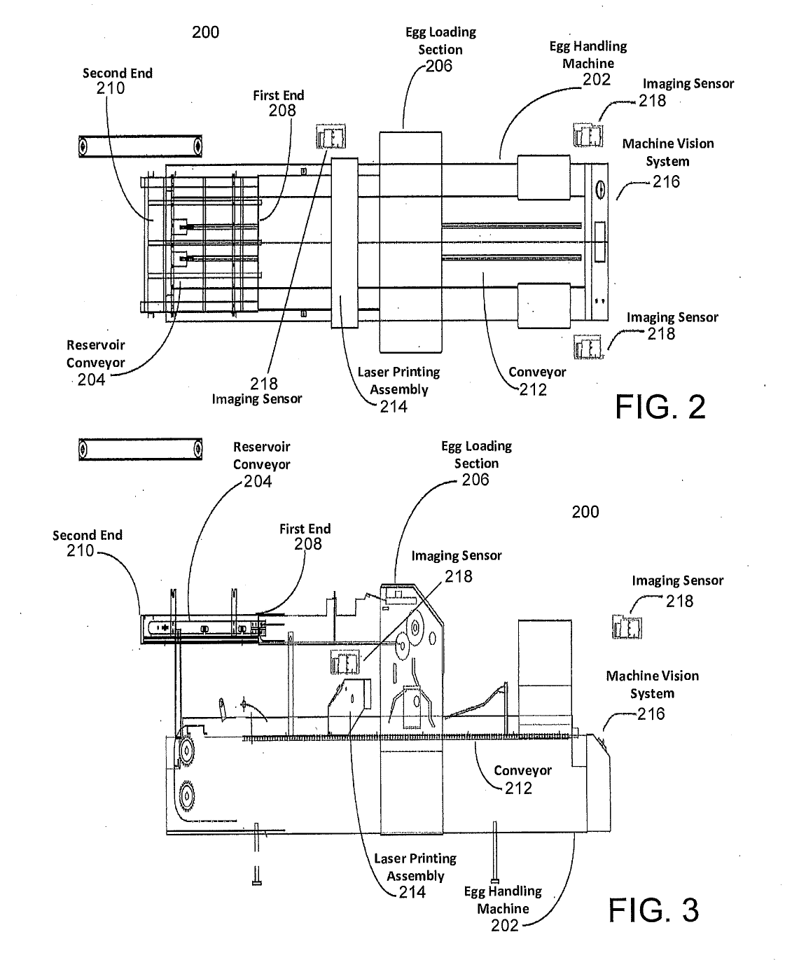

FIG. 2 illustrates a top-view of a system diagram of an example embodiment of a marking apparatus 200 that is operable in association with an egg-handling machine 202 that performs washing, candling, grading, and packing of eggs as discussed above. The apparatus includes at least one laser printing assembly 214 comprised of at least one laser source operable to apply laser markings on eggs. FIG. 3 illustrates a side view of the system diagram of an example embodiment of a marking apparatus 200 that is operable in association with egg-handling machine 202. While reference is made herein to eggs in particular, it should be understood that the same principles and features may be applied to an apparatus for applying marks on other suitable food products. Further, while reference is made to a laser printing assembly comprised of at least one laser source, it should be understood that any suitable marking device may be used, such as an ink-based printing assembly comprised of at least one ink-based printing head.

A reservoir conveyor 204 is connected to an egg loading section 206 of the egg handling machine 202 at first end 208 and an egg grading machine (not shown) at second end 210. In an example operation, eggs are passed from the egg grading machine (not shown) to the reservoir conveyor 204 via the second end 210. The reservoir conveyor 204 then passes the eggs along the conveyor to the first end 208 and then to the egg loading section 206. The egg loading section 206 then receives an egg package (not shown) along a conveyor 212 and then deposits a plurality of eggs into the egg package. The eggs are deposited in the egg package such that the egg package is open and at least a portion of each of the eggs is accessible. In most instances, at least a portion of the eggs extend above the open egg package. Typically the eggs do not travel continuously down the conveyor belt of conveyor 212. Instead as each set of eggs are placed in the egg package at the egg loading section 206, a pause in the conveyor belt of the conveyor 212 occurs. During this pause or dwell time, the at least one laser source in the laser printing assembly 214 prints data on at least one of the eggs in the open egg carton. Preferably, the at least one laser source prints data on each of the eggs in the open egg carton.

The laser printing assembly may be configured on various configurations depending on the markings to be applied onto the eggs and the egg processing speed required in different embodiments or environments. For example, in one embodiment, the laser printing assembly 214 may be situated at the side of the conveyor 212 at a position where a portion of the egg carton is located below the at least one laser source. In another embodiment, the at least one laser source or associated beam delivery or beam deflecting or beam focusing elements may be mounted on a linear slide in the laser printing assembly 214 that moves parallel to the row of eggs during the dwell time and perpendicular to the direction of the conveyor belt of the conveyor 212. Thus, the at least one laser source prints from above the eggs contained in the egg package. The markings may include text, graphics, images, other types of indicia, and any combination thereof. In a preferred embodiment, the markings include freshness information, traceability data, or other types of relevant source information, or any combination thereof. In those embodiments in which the laser source prints from above the eggs, egg debris and/or broken eggs will not fall onto the laser source and therefore, will not cause downtime or impede print quality.

It is be understood that the at least one printing assembly may be positioned at any suitable location for marking on the food products and that the location referenced herein is only for example purposes. Further, the apparatus may include multiple printing assemblies and such printing assemblies may be configured or positioned as required for effective processing.

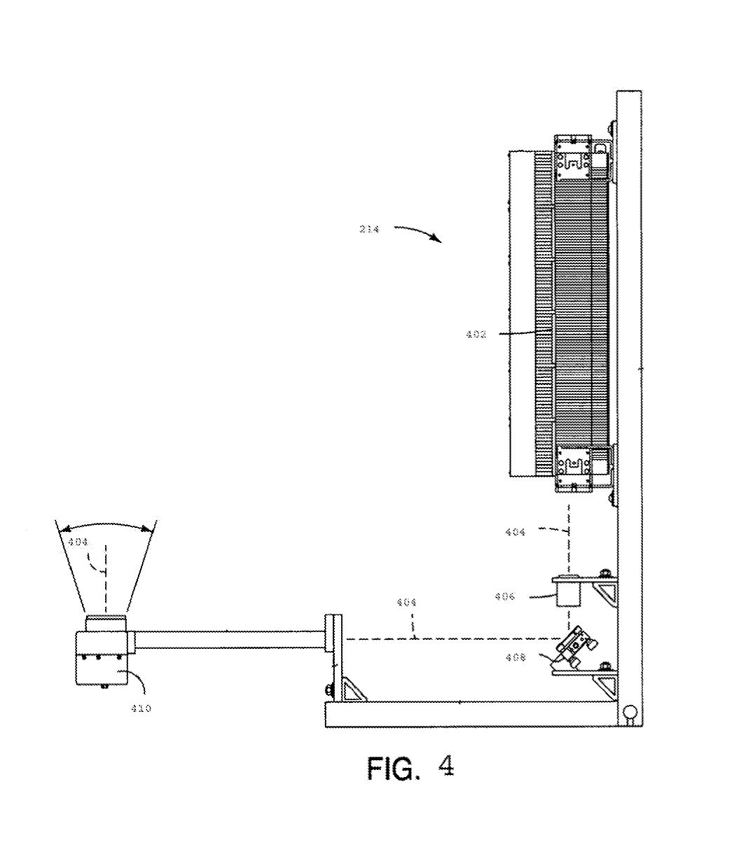

FIG. 4 is a diagram of one embodiment of the laser printing assembly 214 of FIGS. 2 and 3. The laser printing assembly 214 includes at least one laser source 402. The laser source 402 outputs a laser beam 404 that passes through a collimating and focusing lens 406, is then reflected off of mirror 408 to a galvanometer scanning head 410 that directs the laser beam to a specific location on the eggs passing thereunder. The laser printing assembly 214 may also include other components as necessary to interact with the apparatus 200 and apply the desired laser markings to the eggs. The laser printing assembly, which includes at least one laser source, preferably has vector scan and raster scan capability for applying the desired markings to the eggs. The laser printing assembly is in communication with an associated computer, controller, central processing unit, or the like (“computer system”) that controls the operation of the laser printing assembly and the at least one laser source contained therein.

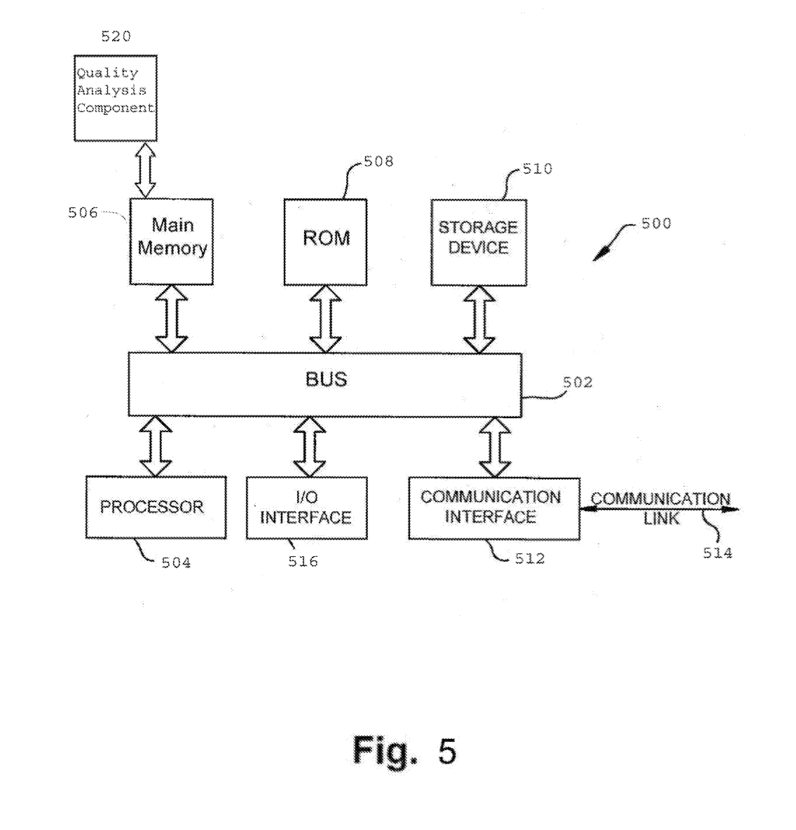

FIG. 5 illustrates an example of a computer system 500 upon which an example embodiment may be implemented. Computer system 500 is suitable for implementing the functionality of any embodiment of the apparatus 200 described herein in FIGS. 2 and 3.

Computer system 500 includes a bus 502 or other communication mechanism for communicating information and a processor 504 coupled with bus 502 for processing information. Computer system 500 also includes a main memory 506, such as random access memory (RAM) or other dynamic storage device coupled to bus 502 for storing information and instructions to be executed by processor 504. Main memory 506 also may be used for storing a temporary variable or other intermediate information during execution of instructions to be executed by processor 504. Computer system 500 further includes a read only memory (ROM) 508 or other static storage device coupled to bus 502 for storing static information and instructions for processor 504. A storage device 510, such as a magnetic disk, optical disk, SD memory and/or flash storage, is provided and coupled to bus 502 for storing information and instructions.

An aspect of the example embodiment is related to the use of computer system 500 to implement the method and system for monitoring and managing food product processing operations, such as applying markings to food products. According to an example embodiment, instructions are provided by computer system 500 in response to processor 504 executing one or more sequences of one or more instructions contained in main memory 506. Such instructions may be read into main memory 506 from another computer-readable medium, such as storage device 510. Execution of the sequence of instructions contained in main memory 506 causes processor 504 to perform the process steps described herein. One or more processors in a multi-processing arrangement may also be employed to execute the sequences of instructions contained in main memory 506. In alternative embodiments, hard-wired circuitry may be used in place of or in combination with software instructions to implement an example embodiment. Thus, embodiments described herein are not limited to any specific combination of hardware circuitry and software.

The term “computer-readable medium” as used herein refers to any medium that participates in providing instructions to processor 504 for execution. Such a medium may take many forms, including but not limited to non-volatile media, and volatile media. Non-volatile media include, for example, optical or magnetic disks, such as storage device 510. Volatile media include dynamic memory, such as main memory 506. As used herein, tangible media may include volatile and non-volatile media. Common forms of computer-readable media include, for example, floppy disk, a flexible disk, hard disk, magnetic cards, paper tape, any other physical medium with patterns of holes, a RAM, a PROM, an EPROM, a FLASHPROM, CD, DVD or any other memory chip or cartridge, or any other medium from which a computer can read. Various forms of computer-readable media may be involved in carrying one or more sequences of one or more instructions to processor 504 for execution. The instructions may optionally be stored on storage device 510 either before or after execution by processor 504.

The computer system 500 also includes a communication interface 512 coupled to bus 502, for providing a two-way data communication coupling computer system 500 to communication link 514. Communication link 514 typically provides data communication to other networks or devices. Although the illustrated example has one communication interface 512 and one communication link 514, those skilled in the art should readily appreciate that this is for ease of illustration, as the example embodiments described herein may have any physically realizable number of communication interfaces 512, and/or communication links 514. The computer system 500 may further include at least one input/output interface 516 connected to the bus 502 and in data communication with one or more user interface devices, such as a mouse, keyboard, monitor/screen, etc. (not explicitly shown).

Notably, while the illustrative embodiment described below shows a single computer system as performing the functions described herein, it is understood that the computer system 500 may comprise, either as a single computer system or as a collection of computer systems, one or more memories, one or more processors, and one or more network interfaces etc., as may be appreciated by those skilled in the art.

The computer system 500 is operable to control the operation of the printing assembly and the at least one printing source contained therein. The computer system 500 is also operable to receive and/or generate data files for producing or generating movement of the marking device to produce the desired markings. The computer system 500 is operable to control various parameters of the marking device, enabling optimization of the performance the marking device in accordance with the quality data obtained from the monitoring and management of the printing process.

In a preferred embodiment, the computer system 500 is operable to control the operation of the laser printing assembly and the at least one source contained therein. The computer system 500 is also operable to receive and/or generate data files containing vector and/or rector information for producing or generating movement of the marking device to produce the desired markings. The computer system 500 is operable to control various parameters of the laser beam, such as power, spot size, spot area, laser speed, pulse width, pulse frequency, and/or modulation frequency. This enables optimization of laser performance with respect to desired resolution, quality, integrity, regulatory compliance, and the like of the applied marks. The magnitude and character of these parameters may be associated with the vector and raster information and stored in memory and programmably varied according to the desired results.

The computer system 500 is preferably interconnected with other computer systems, sensors devices, and other devices associated with other machines, systems, networks, and the like that interact with the apparatus 200 as set forth in FIGS. 2 and 3. For example, the computer system 500 is preferably interconnected with the computer system that controls and monitors the operation of the egg-handling machine 202. The computer system preferably receives environmental and product information from the egg-handling machine, such as wash water temperature, rinse water temperature, wash water pH values, egg origin and characteristic information, and the like. The computer system also preferably receives information from position sensors which monitor the operating status of all important moving components of the apparatus 200.

In one embodiment, the environmental information, product information, positional information, and other relevant processing information may be obtained using image capturing devices, machine-readable or human-readable sensors and identifiers, radio frequency identification transponders (RFID) or other transmitting sensors, time stamps or biometric identification, object recognition, texture definition, database management, and other software, data interface equipment consisting of serial, parallel, or network communication, binary data such as switches, gates, push buttons, current sensors, as well as additional forms of data input. The computer system 500 processes the obtained data and uses such data in the control and operation of the printing assembly as well as the associated egg-handling machine. By adjusting the characteristics of the marking applied thereon, a more consistent mark is achieved and variations of marking quality, resolution, integrity, regulatory compliance, and the like between different types of eggs, environments, and the like may be reduced and/or eliminated.

Egg origin and characteristics of the eggs on which the laser marking is to be applied, or the environmental or processing conditions to which the eggs are subject, may affect the quality of the mark to be applied thereon. These factors include, but are not limited to:

Shell composition (chemical);

Shell composition (mechanical features);

Shell thickness;

Percentage of cuticle remaining;

Shell strength;

Species of bird (chicken, ducks, turkeys, etc.);

Breed of bird;

Feed for bird;

Water source for bird;

Barn temperature;

Molt cycle;

Age of bird;

Age of the egg

Color of egg;

Egg weight (individual and package);

Egg grade;

Egg surface temperature at time of lasing;

Egg wetness at time of lasing;

Egg internal temperature at time of lasing;

Thermal conductive coefficient of egg shell;

Curvature of egg relative to the marking;

Egg washing process parameters;

Egg rinsing parameters;

Egg drying parameters;

Temperature and humidity in the packing facility;

Time of day;

Egg packaging parameters;

Peak temperature reached;

Degree of focus of the laser during marking;

Movement of egg during marking;

Temperature of air local to marking point; and

Effectiveness of vacuum system.

Data relating to the characteristics associated with eggs or the processing or environmental conditions may be obtained by any suitable means. For example, the egg origin and characteristic information of the eggs may be obtained from the source providing the eggs, inspection/examination prior to the processing, data obtained from previous processing of similar types of eggs, data received or obtained by the computer system 500 during monitoring of the marking process, or any other means. Data relating to the environmental conditions, processing parameters, and the interaction of the laser with the egg shell may be obtained from previous processing of similar types of eggs, data received or obtained by the computer system 500 during monitoring of the marking process, or any other means. The computer system preferably stores the data in memory and uses such data as necessary in the control and operation of the laser printing assembly as well as in the control and operation of the egg-handling machine.

In accordance with an embodiment of the present disclosure, the performance or characteristics of the laser may be adjusted in response to selected characteristics of the food product in order to optimize the marking applied thereon. Further, the interaction of the laser with the food product may be monitored by any suitable means and the depth or other characteristics of the laser marking may be adjusted in response to such parameters. By adjusting the depth or other characteristics of the laser marking applied thereon, a more consistent mark is achieved and variations of marking quality between different types of eggs, environments, and the like may be reduced and/or eliminated.

The laser performance parameters may be suitably set or adjusted based on the egg characteristics, environmental conditions, processing conditions, interaction with the laser and the egg shell, and combinations thereof. In a preferred embodiment, the computer system 500 controls various parameters of the laser printing assembly and the at least one laser source to optimize the laser marking process. The parameters that may be set or adjusted include, but are not limited to:

Laser power;

Spot size;

Depth of field;

Speed of traverse of the laser beam over the surface of the object being marked;

Number of passes;

Dwell-time between passes;

Power settings within/between passes;

Spot size of laser beam within/between passes;

Speed of traverse within/between passes;

Order of passes;

Dwell-time in corners of characters;

Configuration of character fonts;

Configuration of any graphical objects to be marked;

Localized heat buildup;

Laser pulse frequency; and

Laser wavelength.

The laser performance parameters may be set or adjusted prior to the laser marking process, during the laser marking process in response to quality data obtained during processing, or any combination thereof. The laser performance parameters may be set or adjusted per egg, per batch, per run, or any combination thereof. Preferably, the laser performance parameters are adjusted to optimize the laser marking applied thereon such that a more consistent marks is achieved and variations in marking quality are reduced and/or eliminated. In a preferred embodiment, the depth of the laser marking on the egg is adjusted to optimize the marking applied thereon as well as maintain the structural integrity and biological barrier integrity of the egg shell.

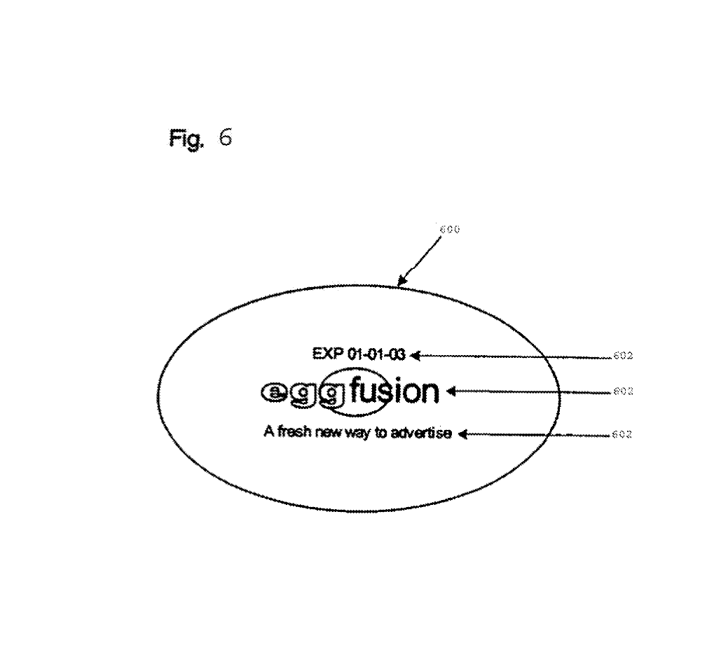

FIG. 6 is a diagram illustrating an egg 600 having indicia laser marked thereon 602 in accordance with the present disclosure. The information marked thereon may include text, graphics, images, other types of indicia, and any combination thereof, and can include an advertisement or other promotional information, freshness information, traceability data, or other types of relevant information.

In accordance with the embodiments, the method and system disclosed herein provide for monitoring and managing food product processing operations and facilities. The food products are examined and/or analyzed with respect to the quality and integrity of the processing thereof, any markings applied thereto, and compliance with commercial, regulatory, or customer requirements, and the like (“quality data”). The environmental conditions, processing conditions, the processing performance parameters, and the like, or any combination thereof, to which the food products are subjected may be adjusted in response to such examination. The quality data may be accessed and analyzed by any suitable means.

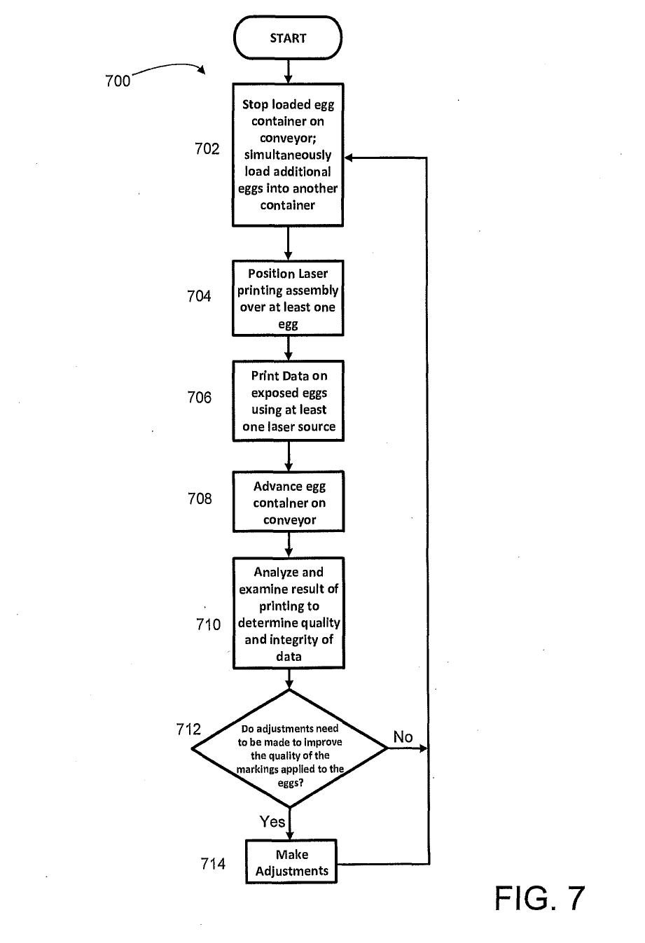

FIG. 7 is an example flow diagram 700 of laser marking on eggs with the apparatus 200 as shown in FIGS. 2 and 3 in accordance with an example implementation. An egg carton stops for a predetermined period of time under the egg loading section 206 which loads the eggs into an egg container. Simultaneously while an egg container is being loaded by the egg loading section 206, a loaded egg container is stopped on the conveyor 212 under the laser printing assembly 214 as shown at 702. The at least one laser source contained within the laser printing assembly 214 is positioned over at least one egg in the egg container as shown at 704. The at least one laser source prints data onto the exposed eggs in accordance with the desired laser performance parameters as shown at 706. The egg container is then advanced on the conveyor 212 as additional eggs are placed in an egg container by the egg loading section 206 as shown at 708. At 710, the eggs having data printed thereon are analyzed and examined as discussed above to determine the quality and integrity of the data printed thereon as well as the structural integrity of the eggs. In response to such analysis and examination, the computer system 500, or other suitable means, determines if any of the laser performance parameters, environmental conditions, and/or processing conditions need to be adjusted to improve the quality or integrity of the markings applied to the eggs or the marking process as shown at 712. If it is determined that certain parameters and/or conditions need to be adjusted, such adjustments are made by any suitable means as shown at 714. The next container of eggs is then processed according to such parameters and laser marking process continues again as shown at 702. If it is determined that the parameters do not need to be adjusted, the laser marking continues again as shown at 702.

The food products may be examined prior to, during, and/or after any processing operation performed thereon. In some embodiments, the food products may be examined based one or more characteristics associated with the food source, food processing facility, food processing environmental conditions, food processing parameters, food product characteristics, distribution details, compliance details, any markings applied thereon, and the like, or any combination thereof (“quality analysis factor”). The quality analysis factors are suitably used to determine whether and/or which food products should be subjected to quality analysis examinations. For example, it may be known that certain types of eggs are more susceptible to weakened egg shell integrity upon marking thereon. Therefore, at least a portion of such eggs should be examined by suitable means to determine if there is any weakening and the extent thereof, if any. Associated corrective actions may be triggered and carried out in response to the results of the examination.

The quality analysis factors that are used for a particular food processing operation and/or facility may be selected or determined by any suitable means. The determination as to which of the food products should be subjected to any quality analysis examinations, to which of the quality analysis examinations the food products should be subjected, what quality data should be obtained, and the details related thereto may also be provided or determined by any suitable means. In a preferred embodiment, the computer system 500 includes a quality analysis component 520, which is any suitable software that enables the computer system to perform quality analysis examinations on selected food products, associated processing operations, and the like based on or with respect to selected quality analysis factors. The quality data obtained from such examinations is then stored and/or processed accordingly.

It is to be understood that quality analysis component 520 may suitably be implemented as logic operable to be executed by processor 504. “Logic”, as used herein, includes but is not limited to hardware, firmware, software and/or combinations of each to perform a function(s) or an action(s), and/or to cause a function or action from another component. For example, based on a desired application or need, logic may include a software controlled microprocessor, discrete logic such as an application specific integrated circuit (“ASIC”), system on a chip (“SoC”), programmable system on a chip (“PSOC”), a programmable/programmed logic device, memory device containing instructions, or the like, or combinational logic embodied in hardware. Logic may also be fully embodied as software stored on a non-transitory, tangible medium which performs a described function when executed by a processor. Logic may suitably comprise one or more modules configured to perform one or more functions.

In a preferred embodiment, the computer system receives data related to the quality analysis factor which are to be used in a particular processing operation, processing facility, processing conditions, and the like, the quality examinations that are to be performed with respect thereto and the process therefore, the quality data to be obtained, or any combination thereof via the quality analysis component 520. Such data may be received from or generated by an associated user, other computer system, device, network, or the like, and may be provided to the computer system through the input/output interface 516 via a suitable user interface, though the communication interface 512, via the communication link 514, via a computer readable medium, and the like. Such data may be received from a single source or multiple sources.

It is to be understood that any number of quality analysis factors and the quality analysis examinations performed with respect thereto may be used depending on the food source, food processing facility, food processing environmental conditions, food processing parameters, food product characteristics, distribution details, compliance details, any markings applied thereon, and the like. As an example, with respect to applying markings on eggs, quality analysis factors include, but are not limited to:

Egg characteristics (breed, size, grade, age, etc.);

Source (location, environmental conditions, etc.);

Transportation/distribution details;

Processing facility;

Processing device/location within facility;

Processes performed prior to and/or after marking (egg-handling)l

Marking process performance parameters;

Marking process environmental conditions;

Marking device/location within the facility;

Inspection device/location within the facility;

Packaging (type, process, etc.);

Processing schedule;

Maintenance schedule for facility, processing device;

Commercial, regulatory, customer compliance issues;

Quality assurance procedures/schedule;

Contamination issue (outbreak, prevention, control);

Barn or agricultural conditions;

Dead or sick animals in vicinity;

Evidence of rodents or other pests, densities and quantities thereof; and

Evidence of flies, density and quantities thereof.

Quality analysis factors and the quality analysis examinations performed with respect thereto may vary with respect to processing schedules, certain stages of the processing operations, selected food product characteristics, environmental conditions, processing conditions, or performance parameters, certain compliance requirements, or any combination thereof. For example, certain quality analysis factors and the quality analysis examination process performed with respect thereto may be used for eggs from a particular source, but not for eggs from a different source. Further, select quality analysis factors may be determinative for subsequent examination for eggs which are subjected to certain egg-handling or washing procedures. Example embodiments of quality analysis that may be performed are discussed below. It is to be understood that such examples are not an exhaustive list, and that other quality analysis factors and examinations are possible.

In one embodiment, at least a portion of the eggs are examined or analyzed during and/or after the laser marking process to determine the position and/or characteristics of the eggs that are to be marked and/or the quality and integrity of the information that is marked on the eggs. Any number of environmental and processing conditions may be analyzed to produce a specific optimized or improved marking on the eggs in response to the analyzed conditions. For example, the laser performance parameters may be adjusted by maximizing or increasing the change in color caused by the directed energy from the laser, reducing the localized depth of mark caused by the directed energy on the egg shell, increasing the speed at which such change in color can occur, or improving the consistency of any other parameter that may be determined between one egg and another.

In some embodiments, at least a portion of the eggs are analyzed to determine the depth of the laser marking applied thereon by any suitable means. In one embodiment, a two dimensional profilometer is contacted with the egg shell to verify and/or determine the depth of the laser marking. The resulting surface profile is analyzed to determine the amount of material ablated or melted from the egg shell during the marking process. In another embodiment, non-contact telemetry measurements may be used to measure the egg's surface and the depth of the marking. Examples of such telemetry methods include, but are not limited to, laser-based methods (visible and/or invisible lasers), structured light, interferometer, stereo-camera based, galvo-based laser scanning, 2-axis translation scanning, and the like. In each of these, the resulting surface profile is analyzed to determine the amount of material ablated or melted from the egg shell during the marking process. Preferably, the depth measurements are performed close to the laser source. The depth measurements may be performed while the egg is moving relative to the measurement device, while the egg is stationary, or combinations thereof. The laser performance parameters are suitably adjusted in response to such depth measurements to optimize the marking applied thereon as well as maintain the structural integrity of the egg shell.

In another embodiment, at least a portion of the eggs have quality markings applied thereto by any suitable means. The eggs having such quality marks are examined or analyzed during and/or after the laser marking process to assess the quality and integrity of such quality mark. The eggs having such quality marks may be processed under similar conditions to other eggs to assess the environmental and processing conditions to which the eggs are subjected. In another embodiment, the eggs having such quality marks are processed under differing environmental and processing conditions to determine the optimal conditions for processing such eggs. Data associated with the quality marked eggs is obtained by any suitable means and may be stored in memory. The obtained data is then analyzed via any suitable means, such as statistical analysis, to determine any variations in the parameters which resulted in changes in the quality marks and to determine the desired parameters for optimal marking of the eggs. Preferably, the laser performance parameters are adjusted in response to such analysis for optimized printing. Preferably, containers including eggs having a quality mark applied thereon are left open for examination of the marks and to easier identification of containers containing quality marked eggs. Preferably, eggs having such quality marks are not distributed to consumers, so containers having such eggs may be diverted from the routine packaging process.

In some embodiments, a machine vision system 216 may be configured and arranged so as to the examine the position and characteristics of eggs that are to be marked and/or the quality and integrity of the information that is marked on the eggs. In some embodiments, one or more machine vision observation units or imaging sensors 218 may be positioned, for example, adjacent the laser printing assembly 214. In other embodiments, the one or more imaging sensors 218 may be located elsewhere to allow for adequate observation. In a preferred embodiment, the machine vision system 216 is operable to control the operation of the one or more imaging sensors 218 and to receive image data obtained from the one or more imaging sensors 218. The machine vision system 216 is also operable to receive and transmit data to the computer system 500.

As used herein, the phrase “imaging sensor” refers to a component of a vision system that captures image data, e.g., a camera or other image capturing device. In machine vision systems, one or more imaging sensors are configured and arranged to capture image data of one or more areas of interest within a facility. Imaging sensors include analog video cameras, digital video cameras, color and monochrome cameras, closed-circuit television cameras, charge-coupled device sensors, complementary metal oxide semiconductor sensors, analog and digital cameras, PC cameras, pan-tilt-zoom cameras, web cameras, infra-red imaging devices, and any other devices that can capture image data. The selection of the particular camera type and selection of the connected machine vision system for a particular facility may be based on factors including environmental lighting conditions, the frame rate and data acquisition rate, and the ability to process data from the lens of the camera within the electronic circuitry of the camera control board, the size of the camera and associated electronics, the ease with which the camera can be mounted as well as powered, the lens attributes which are required based on the physical layout of the facility and the relative position of the camera to the area of interest, and the cost of the camera.

In some embodiments, the system includes artificial light sources operating at certain frequencies of light which result in preferential image capture, such as “Red Light” or “Blue Light.” In other embodiments, multiple images are captured under alternating light conditions to allow for better comparative analysis of the image data, such as using multiple images representing the same region of interest under differing lighting conditions. In yet other embodiments, no artificial lighting is required, and ambient lighting suffices.

The machine vision system 216 and the associated imaging sensors 218 may capture and/or generate any type or format of image data useful for quality analysis of the eggs. For example, image data may be captured while the egg is moving relative to the imaging sensors or while the egg is stationary. Further, the image data may be two-dimensional or three-dimensional as is required for quality analysis thereof. In a preferred embodiment, image data of an egg is captured while the egg is stationary as eggs are not of uniform shape or mass distribution, and thus it is hard to fixture.

Quality control marks are made while the eggs are located in an egg carton within the standard marking process. This ensures that the marking process being analyzed is being completed using the same laser and other parameters as the production eggs. Egg cartons are typically designed to accommodate as wide a range of egg shapes and sizes as possible—essentially the pocket holding the egg is made as large as possible within the constraints of the required spacing between eggs, overall carton size envelope, and manufacturing process constraints for the carton. This space around a typical egg in the pocket, means that the egg is not consistently positioned (e.g. always having its long axis vertical) and therefore typically the QC mark is not in the same location on the egg, relative to the vertical axis.

If fixturing were to be developed that (for instance) rotated the egg on its long axis during measurement, then the location of the quality control markings is not consistent from sample to sample. Therefore in this embodiment it is more effective for an operator to locate the mark on the egg with respect to the measuring device, placing the egg into a simple fixture so that the marking is directly accessible to that system (e.g. within the system's field of view), as opposed to having to search for the marking's location anywhere on the egg using an automated system.

The egg may then be suitably moved between passages of the image sensors thereover and settling time is provided before the next passage is captured. In a preferred embodiment, the surface characteristics between the marked areas are captured, and such image data is used for quality analysis.

In one embodiment, the system as disclosed herein may be stopped if the machine vision system 216 determines that the mark quality, egg shell integrity, compliance threshold, or the like, has fallen below a certain threshold. In some embodiments, such a system may be a closed-loop such that feedback from the machine vision system 216 may be used to control the laser printing assembly 214 so as to improve the quality and reliability of the process. For example, feedback from the machine vision system 216 might result in corrective actions such as adjustment in the number of passes made, the scan rate, the power level of the laser, etc., in order to ensure a desired contrast level is achieved during the laser marking process.

Additionally, or alternatively, the machine vision system 216 may examine the size, color, or other perceptible properties of the eggs to be marked and make appropriate adjustments to the laser performance parameters and/or process to account for such variables and thereby ensure that image quality stays consistent in spite of such variations.

In one embodiment, the machine vision system results are stored in a database and subsequently analyzed to detect patterns using statistical analysis, which may indicate specific failure modes or degradation in quality of mark. As a natural product, the suitability for marking of the egg surface once washed and processed by the egg processing machinery, will vary between eggs. Therefore an individual egg with a lower quality mark, may indicate a harder-to-mark egg, or may indicate a degradation in marking system, or vision system, performance. For this reason, it is necessary to analyze vision inspection results from several eggs in aggregate, whether such eggs are grouped by at least one of:

1. only eggs marked using an individual single laser marking system, or

2. only eggs inspected by an individual image sensor or associated machine vision system, or

3. only eggs processed by an individual packer machine within the egg processing facility, or

4. only eggs processed at a range of times in the day, or

5. only eggs processed when washing system parameters are within specific limits, or

6. only eggs retrieved from a specific barn or section of a barn where the eggs are laid, or

7. only eggs from a specific source farm, or

8. only eggs processed at a specific egg processing facility, or

9. only eggs processed during a specific range of dates, or

10. any other grouping by process parameter, source location, processing location, environmental parameters at the source location or processing location, transportation parameters, or the like.

It is typical to examine machine vision system inspection results from at least 100 eggs grouped by one or more of the categories listed above. In a preferred embodiment, at least 500 machine vision inspection results from eggs are analyzed in aggregate to determine the extent, if any, or mark quality degradation.

Patterns thus detected in the machine vision system results are utilized to determine appropriate corrective actions, which may include:

1. Cleaning of components, especially the lens or other beam delivery components of the laser marking system; or

2. Adjustment of relative the position of the egg and laser or ink marking system, during marking, or

3. Adjustment of the offsets used by the marking system, to move the mark on the eggs; or

4. Adjustment of laser marking parameters as noted above, or

5. Replacement of failed or failing components of the systems, or

6. Cleaning of the imaging sensors or recalibration of the machine vision system to suit environmental conditions, or

7. Adjustment of mechanical aspects of the egg packing machinery to better orient or otherwise present the eggs to the laser or ink marking system for marking, or

8. Adjustment of washer equipment to bring the washer parameters back to the ideal characteristics for laser or ink marking of eggs, or

9. Adjustment of other egg grading or packing machine parameters, including but not limited to machinery speed, mechanical adjustments, or the like, or

10. Other corrective actions as deemed necessary by those skilled in the art.

Required and/or recommended corrective actions are presented to persons at the egg processing for implementation, using any suitable means of communication, including email, text messaging, displays on HMI screens, or the like.

Ongoing machine vision system inspection results, when grouped and analyzed as described above, provide feedback as to the effectiveness of the corrective actions implemented.

It is to be understood that any of the examination results obtained, such as depth of mark, laboratory results, and the like, may be grouped and analyzed as discussed with respect to machine vision system results.

In another embodiment, at least a portion of the eggs are analyzed prior to marking thereon to determine whether to proceed with the marking process. For example, the eggs may be analyzed to determine if the eggs are of sufficient quality and integrity to have markings applied thereon. As an example, the eggs may be analyzed with respect to prior processing to determine if the processing thereon was performed in compliance with established procedures and thresholds. The eggs may also be analyzed to determine if such prior processing comprised the integrity of the egg shell, to what extent, and if the egg shell can withstand marking thereon.

In an example embodiment, at least a portion of the eggs are analyzed after being washed to determine if the washing procedure was performed according to standard procedures, was compliant with any commercial, regulatory, or customer requirements, and the like. For example, if the eggs were not washed within the proper temperature range, any contaminants that may be on the shell may not be removed, structural integrity may be comprised, and the like. As discussed above, data relating the environmental conditions and process parameters of the washing procedure is obtained, including, but not limited to, egg temperature, wash water temperature, wash water quality, wash water pH, detergent type, etc. If it is determined that any of the environmental conditions or process parameters are not within the determined threshold ranges, then corrective action is taken. For example, the washing parameters may be adjusted accordingly, the eggs washed again and examined, and if the washing procedure and/or the eggs are deemed compliant, the eggs are marked accordingly.

It is understood that it may be undesirable to analyze each egg for cost and processing time reasons. Therefore, in some embodiments, a portion of the eggs processed are routed to a quality analysis station for analysis and examination. The eggs may be routed to such quality analysis station prior to, during, and/or after processing thereof. The eggs are subjected to the analysis and examination as discussed above.

In a preferred embodiment, quality data is also collected from third parties, wherein such third party is an entity other than the egg processing facility. Such third party may be the source location, veterinary facilities, testing laboratories, distributors, and the like. Such third parties will obtain and/or collect data related to the eggs that are being processed as well as environmental and processing conditions associated with eggs. The quality data obtained therefrom may have an impact on the quality and integrity of the processing.

In another embodiment, at least a portion of the eggs may be analyzed as a result of a specified event or trigger (“trigger event”) that is associated with the food source, food processing facility, food processing environmental conditions, food processing parameters, food product characteristics, distribution details, compliance details, any markings applied thereon, and the like. The occurrence of a trigger event will result in at least a portion of the food products or associated processing thereof to be subjected to one or more quality analysis examinations. As an example, following repair or maintenance being performed on a laser marking assembly, at least a portion of the eggs being processed there through will be examined as to the quality and integrity of markings applied to the eggs. Based on the quality data obtained, the laser processing parameters may be adjusted accordingly.

The trigger events that are used for a particular food processing operation and/or facility may be selected or determined by any suitable means. In a preferred embodiment, the computer system receives data related to the trigger events via the quality analysis component 520. Such data may be received from or generated by an associated user, other computer system, device, network, or the like, and may be provided to the computer system through the input/output interface 516 via a suitable user interface, though the communication interface 512, via the communication link 514, via a computer readable medium, and the like. Such data may be received from a single source or multiple sources.

It is to be understood that any number of trigger events may be set depending on the food source, food processing facility, food processing environmental conditions, food processing parameters, food product characteristics, distribution details, compliance details, any markings applied thereon, and the like. As an example, with respect to applying markings on eggs, trigger events include, but are not limited to:

Change in type of eggs being processed;

Change in source of eggs being processed;

New processing facility coming online;

New processing device coming on line;

Processing facility/device coming back on line after repair/maintenance;

Change in processes performed prior to and/or after marking (egg-handling);

Change in marking process performance parameters;

Change in marking process environmental conditions;

Marking device coming back online after repair/maintenance;

Change in processing schedule (new time, day);

Change in commercial, regulatory, customer compliance issues;

Change in quality assurance procedures/schedule; and

Contamination issue (outbreak, prevention, control).

Based on the occurrence of selected trigger event, at least a portion of the eggs will be subjected to one or more quality assurance examinations associated with the trigger event. The parameters for which food products are to be examined, which quality assurance examinations are to be performed, sample size, quality data to be obtained, corrective actions, and the like (“testing protocol”) are determined or provided by any suitable means. In a preferred embodiment, the computer system receives data related to the testing protocol to be followed in response to a selected trigger event via the quality analysis component 520. Such data may be received from or generated by an associated user, other computer system, device, network, or the like, and may be provided to the computer system through the input/output interface 516 via a suitable user interface, though the communication interface 512, via the communication link 514, via a computer readable medium, and the like. Such data may be received from a single source or multiple sources.

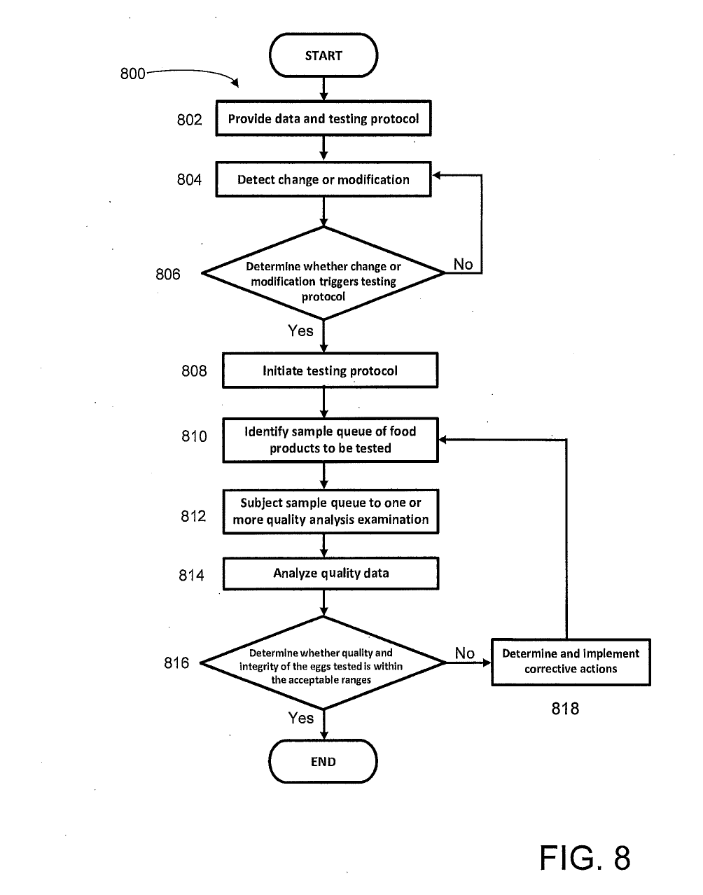

FIG. 8 is an example flow diagram 800 illustrating the occurrence of a trigger event and the implementation of the testing protocol associated therewith. At 802, data related to a trigger event and the testing protocol associated with an occurrence of the trigger event are provided. At 804, a change or modification relating to the food source, food processing facility, food processing environmental conditions, food processing parameters, food product characteristics, distribution details, compliance details, any markings applied thereon, passing of a specified period of time, completion of prior testing protocol, or the like is detected. At 806, a determination is made whether such change or modification is a trigger event such that the associated testing protocol should be initiated. If such change is not determined be a trigger event, flow proceeds back to 804, until another change is detected.

If a determination is made that such change is considered a trigger event, then flow proceeds to 808, wherein the associated testing protocol is initiated. In a preferred embodiment, the testing protocol is assigned a unique identification number, for which information related to the trigger event (date, time, facility information, processing device information, type of event, etc.) and quality data obtained are associated with such unique identification number.

At 810, the sample queue of food products to be tested is identified in accordance with the testing protocol. The eggs to be tested may be selected based on random number generation, every certain number egg or carton processed (every 10th egg), from one or more locations or devices, from one or more processing runs, or other relevant factors, or any combination thereof. At 812, the sample queue is subjected to one or more quality analysis examinations in accordance with the testing protocol. The sample queue may be examined at a selected quality analysis queue of a processing device, at a quality analysis station, or the like.

The quality data obtained from the one or more examinations is analyzed by any suitable means as shown at 814. The quality data may be examined locally, remotely, or any combination thereof. The quality data may also be stored in memory with its associated unique identification number. A determination is made at 816 based on the analyzed quality data as to whether the quality and integrity of the eggs tested is within the acceptable ranges. If it is determined that the quality and integrity of the eggs is acceptable, the testing protocol may be stopped, and processing operations may return to normal. It should be understood that some testing protocols are carried out without interrupting the normal processing operations. Although, if it is later determined to be out of compliance, eggs processed at that time might be held for further testing, for destruction, or otherwise prevented from entering the food chain.

If it is determined that the quality and integrity of the eggs is not acceptable, corrective actions are determined and implemented as shown at 818. For example, the laser performance parameters, processing conditions, environmental conditions, and the like may be adjusted. Flow then proceeds back to 810 wherein the sample queue is identified and subsequently tested. The process continues until the quality and integrity of the eggs is acceptable.

Quality data obtained prior to, during, and/or after processing of the eggs is suitably stored in memory for later use. The obtained quality data may be stored in memory local to the egg processing facility and/or remotely by any suitable means. The obtained quality data may be accessed and analyzed via any suitable means, such as statistical analysis, to determine any variations, trends, patterns, and the like.

In a preferred embodiment, at least a portion of the quality data is collected and stored in memory for later use. The quality may be collected, consolidated, and then analyzed for any suitable purpose, such as to improve processing control and output, determine output and performance characteristics, improve, determine trends, determine or verify regulatory compliance, identify risks (i.e., processing conditions, environmental conditions, contamination, source, etc.), support product recall procedures, provide source verification, and the like. Quality data may be collected from multiple food products, multiple processing runs on a device or system, multiple marking devices or systems within a processing facility, multiple processing facilities, multiple distribution systems, multiple food sources, and the like, or any combination thereof.

The collected information is then consolidated and stored in memory for later use by authorized users. The consolidated data may be stored locally and/or remotely by any suitable means. In a preferred embodiment, the present disclosure provides a cloud-based system for collecting, consolidating, and disseminating the source information. The quality data contained therein may be analyzed with respect to food source location details, food processing facility details, food processing environmental and processing conditions, food product characteristics, food product distribution details, regulatory compliance details, and the like.

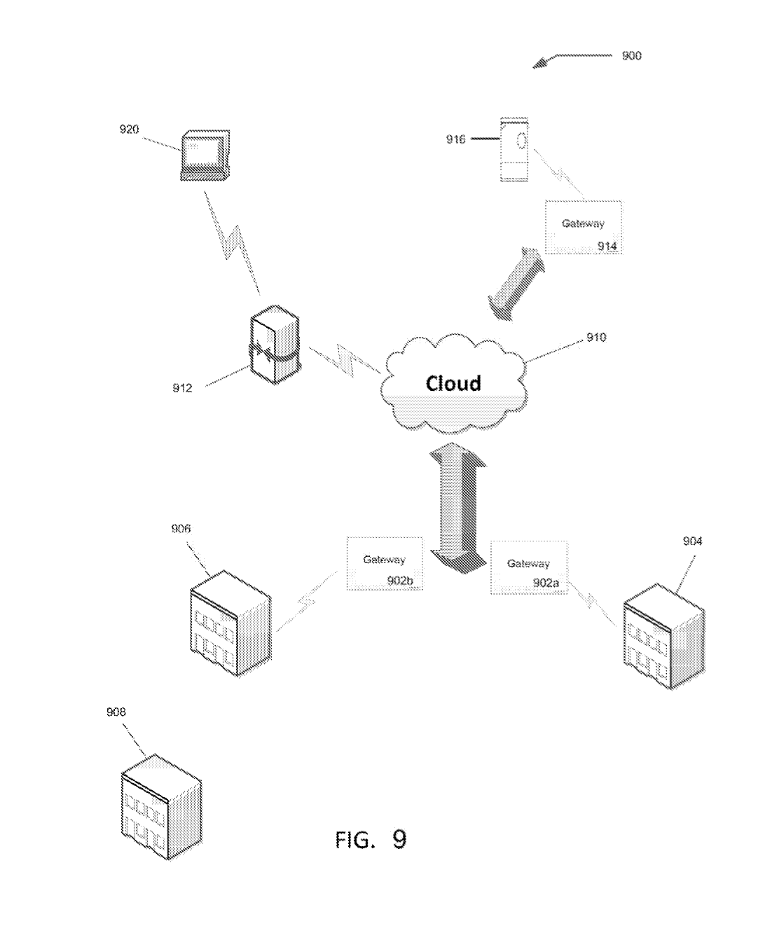

FIG. 9 illustrates an exemplary block diagram of a cloud-based approach for connecting numerous remote devices or systems with a remote storage location having a database or other relational storage component for storing quality data related to the operation of one or more food product processing systems. As an example embodiment, FIG. 9 illustrates a block diagram 900 of a cloud-based approach for storing quality data related to eggs processed by one or more egg processing facilities. In FIG. 9, gateway 902a is in communication with egg processing facility 904 and gateway 902b is in communication with egg processing facility 906. Egg processing facility 906 also processes eggs received from egg processing facility 908. Egg processing facility 908 is an off-line facility that transports eggs to egg processing facility 906, which in turn processes the eggs and transmits the relevant data to gateway 902b. For purposes of this example, all three egg processing facilities 904, 906, and 908 may have received nest run eggs. Egg processing facilities 904 and 906 will apply markings to at least a portion of the eggs processed therein.

Also, as shown in FIG. 9, gateway 914 is in communication with a third party 916, wherein such third party is an entity other than the egg processing facility. Such third party may be the source location, veterinary facilities, testing laboratories, distributors, and the like. Such third parties will obtain and/or collect data related to the eggs that are being processed as well as environmental and processing conditions. For example, samples are taken at the source farm and/or processing facility, such as to test for Salmonella, Avian, Influenza, and the like. Some testing is required to be performed at specific times by federal or state regulations, or by local farming policies. Such samples are preferably collected using a pattern of locations, and are assigned a unique identifier designating location of collection, date, and time. The unique identifier is entered or scanned at the testing location upon arrival at that location and the results are linked back to that unique identifier upon completion of the required testing.

The quality data as it is collected may be transmitted through the cloud 910 to a remote storage location 912. In a preferred embodiment, the quality data is assigned a unique identification number, and the quality data is stored in relation to the unique identification number. Preferably all quality data related to a run, batch, processing facility, source, or the like are associated with the same unique identification number, including data from third parties, for easier reference.

The collected quality data is consolidated and archived, and is available for remote analysis thereof for any suitable purpose, such as to improve processing control and output, determine output and performance characteristics, improve, determine trends, determine or verify regulatory compliance, identify risks, support product recall procedures, provide source verification, and the like. In some embodiments, a portion of the collected and/or analyzed may flow back by way of the cloud 910 through gateway 902a and/or 902b to one or more of the egg processing facilities for use thereby, or through gateway 914 to a third party. The remote storage location 912 may be accessible remotely to consumers, retails, egg providers, egg processing facilities, governmental entities, and other interested party by any suitable remote communication device as illustrated by 920. Preferably, access to the remote storage device is only after suitable authentication and/or encryption processes.

It is appreciated by those skilled in the art that the cloud-based approach shown in FIG. 9 is only an exemplary topology diagram of a cloud-computing methodology and that for purposes of connecting numerous remote devices herein, a cloud-based implementation may take other forms and include other components as necessary.

It is to be understood that the present disclosure is applicable to any suitable animal growing, housing, or farming operations. In addition, the methods and systems of the present disclosure are applicable to any portion of animal growing, housing, or farming operations. As an illustrative example, the methods and systems of the present disclosure allow for any or all of the egg source locations, distribution facilities, egg processing facilities, governmental agencies, and the like to access data related to a particular egg processing operation, group of processing operations, batch of product, source of product, trends related thereto, or combinations thereof. This allows for all data related to a particular processing operation to potentially be aggregated and analyzed across multiple processing operations, batches of product, sources of product, and the like, and such data and analysis stored in a storage location that is readily accessible by any authorized users for further analysis thereof.

Illustrative examples of monitoring and managing food processing operations in accordance with the present disclosure are provided below. One such example relates to Nest Run eggs, wherein the ideal laser parameters will vary for eggs from different farms, different breeds, feed, etc. Therefore, when Nest Run eggs are sourced from an offline farm, the laser parameters most suited for such eggs must be determined and used when processing and marking those eggs.

Another example is example is detection of high pH values in the wash water. Typically, pH values above 12 result in very poor mark quality as too much of the markable layers in the surface of the egg are removed during washing. Therefore, detecting of plant-wide poor mark quality would trigger an inspection of the pH of the wash water, to determine if that is the cause of the poor marking.

A third example is if a house/barn has birds in ‘molt’ (molt results in a hiatus in egg supply by the chickens in the barn), egg shell quality and markability (the ability to be effectively marked by a marking device, such as a laser or inkjet printer) can be affected. Although typically such eggs are mixed freely within eggs from other barns, due to the configuration of the conveyor systems from the barns to the processing areas. If the molting status quality data has been received from the source and stored in relation to such eggs, any poor individual marking results detected could and trigger additional inspections on that egg to determine if the cause of the poor markings is the specific source barn, or another cause.

In some embodiments, egg weight, egg size, shell thickness, shell strength, albumen characteristics such as Haugh units, yolk color, etc. are measured and recorded with the unique identifier number. This allows trends in specific parameters to be identified over time and corrective actions taken (for example a reduction in shell thickness or shell strength might indicate the need for a change in feed composition). Additionally certain regulatory requirements, such as minimum weight for a complete cartons of eggs, can be assessed on a sampled basis.

Some embodiments may include such unique identifiers and behavioral management techniques to drive the ‘egg candling’ process whereby eggs are inspected for cracks and other defects to ensure that the ratio of cracked to uncracked eggs within a batch remains below the levels required by regulation and/or customer requirements.

Some embodiments may include display systems that provide direct real-time feedback of critical processing parameters to processing location operators and supervisors. For example, wash water temperatures and incoming egg temperatures may be displayed, together with the results of analysis of those temperatures to indicate out-of-compliance or in-compliance status. Such direct feedback can prompt corrective actions to be taken to bring processing conditions back into compliance and allow egg processing, including egg marking, to continue. Out-of-compliance status may result in the automatic stopping of egg processing and/or egg marking. An override may be provided so that with suitable authentication, processing can continue (e.g. due to a failed or out-of-calibration sensing system). In such circumstances an increased number of quality controls triggers for manual measurements of processing parameters such as water pH, water temperatures, egg temperatures, and might be required in accordance with the testing protocol and/or corrective action protocol relating to the inspection.

Having thus described certain embodiments of systems and methods for practicing aspects of the present disclosure, it is to be appreciated that various alterations, modifications, and improvements will readily occur to those skilled in the art. Such alterations, modifications, and improvements are intended to be part of this disclosure, and are intended to be within the spirit and scope of this disclosure.

1. A system for analyzing the quality of food processing operations and the food products processed thereby, the system comprising:
at least one processor;
at least one data capture device operatively coupled to the at least one processor and controlled in part by the at least one processor, the at least one data capture device operable to obtain quality data associated with at least one parameter of the food processing operation;
a non-transient memory operatively coupled to the at least one processor and operable to store data associated with the captured data; and
at least one input/output interface operatively coupled to the processor;
wherein the at least one processor is operable to:
obtain data capture parameters with respect to the quality data to be captured by the at least one data capture device, wherein the data capture parameters comprise at least one of at least one characteristic of the food products to be processed, at least one parameter of the food processing operation, at least one characteristic of food products having been processed by the processing operation, and combinations thereof;
obtain at least one quality data analysis parameter with respect to selected analysis to be performed on at least a portion of the quality data;
capture quality data in accordance with at least a portion of the quality data capture parameters;
analyze at least a portion of the captured quality data in accordance with at least a portion of the quality data analysis parameters; and
adjust at least one operational parameter of the food processing operation based on the analysis of at least a portion of the quality data.

2. The system of claim 1, wherein the at least one processor is further operable to store at least a portion of the quality data in memory.

3. The system of claim 2, wherein at least a portion of the memory is implemented in a cloud-based component communicatively coupled to the at least one processor, and is operable to store at least a portion of the quality data.

4. The system of claim 1, wherein
the at least one food product characteristic includes data associated with at least one of food product characteristic details, food product source location details, food product source environmental and processing conditions, food product source regulatory compliance details, food product distribution details, at least one characteristic of at least one pathogen of interest, at least one characteristic of at least one third party that interacts with the food products, the source location, the distributor, and combinations thereof, markings applied thereon, and combinations thereof;
the at least one operational parameter includes data associated with at least one of environmental conditions, processing conditions, markings applied to the food products, regulatory compliance details, scheduling details, processing equipment details, repair and maintenance details, and combinations thereof.

5. The system of claim 1, wherein the at least one quality analysis parameter includes data associated with at least one of selected food processing operations to be analyzed, selected food products to be analyzed, selected quality data to be analyzed, selected analysis to be performed thereon, selected scheduling of analysis to be performed thereon, selected regulatory compliance details to be analyzed, selected events that trigger quality analysis to be performed on at least portion of the food products, food product processing operations, and combinations thereof, and combinations thereof.

6. The system of claim 1, wherein the processor is further operable to:
capture supplemental quality data based on at least a portion of the analyzed quality data;
analyze at least a portion of the supplemental quality data in accordance with at least a portion of the quality data analysis parameters; and
adjust at least one operational parameter of the food processing operation based on the analysis of at least a portion of the supplemental quality data.

7. The system of claim 1, wherein the processor is further operable to:
receive quality data associated with at least one of the food product processing operation, food products to be processed thereby, and combinations thereof remotely via the input/output interface;
analyze at least a portion of the received quality data in accordance with at least a portion of the quality data analysis parameters; and
adjust at least one operational parameter of the food processing operation based on the analysis of at least a portion of the received quality data.

8. The system of claim 1, wherein the process is further operable to:
receive quality data associated with at least one supplemental processing operation performed on the food products remotely via the input/output interface;
analyze at least a portion of the received quality data associated with the at least one supplemental processing operation in accordance with at least a portion of the quality data analysis parameters; and
adjust at least one operational parameter of the food processing operation based on the analysis of at least a portion of the quality data associated with the at least one supplemental processing operation.

9. The system of claim 1, wherein the food processing operation is the marking of indicia onto the food products as the food products pass through a processing system.

10. A method for analyzing the quality of food processing operations and the food products processed thereby, the method comprising:
obtaining data capture parameters with respect to the quality data to be captured by at least one data capture device, wherein the data capture parameters comprise at least one of at least one characteristic of the food products to be processed, at least one parameter of the food processing operation, at least one characteristic of food products having been processed by the processing operation, and combinations thereof;
obtaining quality data analysis parameters with respect to selected analysis to be performed on at least a portion of the quality data;
capturing quality data by at least one data capture device in accordance with at least a portion of the quality data capture parameters;
analyzing at least a portion of the captured quality data in accordance with at least a portion of the quality data analysis parameters; and
adjusting at least one operational parameter of the food processing operation based on the analysis of at least a portion of the quality data.

11. The method of claim 10, the method further comprising storing at least a portion of the quality data in memory.

12. The method of claim 11, the method further comprising storing at least a portion of the quality data in a cloud-based storage component.

13. The method of claim 10, wherein
the at least one food product characteristic includes data associated with at least one of food product characteristic details, food product source location details, food product source environmental and processing conditions, food product source regulatory compliance details, food product distribution details, at least one characteristic of at least one pathogen of interest, at least one characteristic of at least one third party that interacts with the food products, the source location, the distributor, and combinations thereof, markings applied thereon, and combinations thereof;
the at least one operational parameter includes data associated with at least one of environmental conditions, processing conditions, markings applied to the food products, regulatory compliance details, scheduling details, processing equipment details, repair and maintenance details, and combinations thereof.

14. The method of claim 10, wherein the at least one quality analysis parameter includes data associated with at least one of selected food processing operations to be analyzed, selected food products to be analyzed, selected quality data to be analyzed, selected analysis to be performed thereon, selected scheduling of analysis to be performed thereon, selected regulatory compliance details to be analyzed, selected events that trigger quality analysis to be performed on at least portion of the food products, food product processing operations, and combinations thereof, and combinations thereof.

15. The method of claim 10, the method further comprising:
capturing supplemental quality data based on at least a portion of the analyzed quality data;
analyzing at least a portion of the supplemental quality data in accordance with at least a portion of the quality data analysis parameters; and
adjusting at least one operational parameter of the food processing operation based on the analysis of at least a portion of the supplemental quality data.

16. The method of claim 10, the method further comprising:
receiving quality data associated with at least one of the food product processing operation, food products to be processed thereby, and combinations thereof from a remote source
analyze at least a portion of the received quality data in accordance with at least a portion of the quality data analysis parameters; and
adjust at least one operational parameter of the food processing operation based on the analysis of at least a portion of the received quality data.

8. The system of claim 1, wherein the process is further operable to:
receiving quality data associated with at least one supplemental processing operation performed on the food products;
analyzing at least a portion of the received quality data associated with the at least one supplemental processing operation in accordance with at least a portion of the quality data analysis parameters; and
adjusting at least one operational parameter of the food processing operation based on the analysis of at least a portion of the quality data associated with the at least one supplemental processing operation.

18. The method of claim 10, wherein the food processing operation is the marking of indicia onto the food products as the food products pass through a processing system.

19. A system for analyzing the quality of an animal growing, housing, or farming processing operation, wherein the operation processes at least one of animals, animal products, and combinations thereof, the system comprising:
at least one processor;
at least one data capture device operatively coupled to the at least one processor and controlled in part by the at least one processor, the at least one data capture device operable to obtain quality data associated with at least one parameter of the processing operation;
a non-transient memory operatively coupled to the at least one processor and operable to store data associated with the captured data; and
at least one input/output interface operatively coupled to the processor;
wherein the at least one processor is operable to:
obtain data capture parameters with respect to the quality data to be captured by the at least one data capture device, wherein the data capture parameters comprise at least one of at least one characteristic of the animals to be processed, at least one parameter of animal products to be processed, at least one parameter of the processing operation, at least one characteristic of animals having been processed, at least one characteristic of animal products having been processed, and combinations thereof;
obtain at least one quality data analysis parameter with respect to selected analysis to be performed on at least a portion of the quality data;
capture quality data in accordance with at least a portion of the quality data capture parameters;
analyze at least a portion of the captured quality data in accordance with at least a portion of the quality data analysis parameters; and
adjust at least one operational parameter of the processing operation based on the analysis of at least a portion of the quality data.

20. The system of claim 19, wherein the animal products are eggs.
